(19) United States
(12) Patent Application Publication
(10) Pub. No.: US 2017/0089298 A1
(43) Pub. Date: Mar. 30, 2017

(54) DEPLOYMENT MECHANISM FOR INFLATABLE SURFACE-INCREASING FEATURES FOR GAS TURBINE ENGINE

(71) Applicant: PRATT & WHITNEY CANADA CORP., Longueuil (CA)

(72) Inventors: Ninad Joshi, Brampton (CA); Sid-Ali Meslioui, Brossard (CA)

(21) Appl. No.: 14/867,939

(22) Filed: Sep. 28, 2015

(51) Int. Cl. F02K 1/64; F02C 7/24; F01D 25/30

(52) U.S. Cl. CPC F02K 1/645; F01D 25/30; F02C 7/24; F05D 2260/96

(57) ABSTRACT

A deployment mechanism for inflatable surface-increasing features a gas turbine exhaust case comprising a plurality of inflatable surface-increasing features adapted to be circumferentially distributed within the gas turbine exhaust case at a trailing edge thereof. The inflatable surface-increasing features are inflatable from a stowed configuration in which the inflatable surface-increasing features are substantially concealed fore of the trailing edge, to a deployed configuration in which the inflatable surface-increasing features extend beyond the trailing edge. A pressurizing system in fluid communication with the plurality of chevrons inflates and deflates the inflatable surface-increasing features.

### TECHNICAL FIELD

The application relates generally to gas turbine engines and, more particularly, to turbine exhaust cases, fan ducts, or tabs nozzle therefor.

### BACKGROUND OF THE ART

The exhaust jet of a gas turbine engine is a significant noise source, particularly at high power conditions, which may drive the overall aircraft noise affecting communities surrounding airport and the cabin noise. Chevrons located at the trailing edge of nozzles have emerged as an effective means of reduction of jet noise for mid-to-high bypass ratio turbo-fan engines. The chevrons are typically shaped as saw-tooth patterns on the trailing edges of jet engine nozzles. The chevron nozzles induce additional mixing mechanisms altering the shear layer thereby promoting a rapid plume decay and resulting in noise reduction. This may however be accompanied by an increased drag which results in a deterioration of the performance of the gas turbine engine.

### SUMMARY

In one aspect, there is provided a deployment mechanism for inflatable surface-increasing features a gas turbine exhaust case comprising: a plurality of inflatable surface-increasing features adapted to be circumferentially distributed within the gas turbine exhaust case at a trailing edge thereof, the inflatable surface-increasing features being inflatable from a stowed configuration in which the inflatable surface-increasing features are substantially concealed fore of the trailing edge, to a deployed configuration in which the inflatable surface-increasing features extend beyond the trailing edge; and a pressurizing system in fluid communication with the plurality of chevrons to inflate and deflate the inflatable surface-increasing features.

In a second aspect, there is provided a gas turbine engine comprising: a turbine case defining an annular cavity; a plurality of inflatable surface-increasing features circumferentially distributed within the annular cavity at a trailing edge thereof, the inflatable surface-increasing features being inflatable from a stowed configuration in which the inflatable surface-increasing features are substantially concealed within the turbine case, to a deployed configuration in which the inflatable surface-increasing features extend outside the turbine case at the trailing edge, and a pressurizing system in fluid communication with the plurality of inflatable surface-increasing features to inflate and deflate the inflatable surface-increasing features between the stowed configuration and the deployed configuration.

In a third aspect, there is provided a method for deploying chevrons at a trailing edge of a gas turbine exhaust case of an aircraft, comprising: directing pressurized fluid to a plurality of inflatable surface-increasing features at the trailing edge of the exhaust case; and inflating the plurality of inflatable surface-increasing features to a deployed configuration in which the inflatable surface-increasing features are inflated to extend beyond the trailing edge of the exhaust case.

Further details of these and other aspects of the present invention will be apparent from the detailed description and figures included below.

### DESCRIPTION OF THE DRAWINGS

Reference is now made to the accompanying figures, in which:

FIG. 1 is a schematic cross-sectional view of a turbofan gas turbine engine;

FIGS. 2A and 2B are a schematic enlarged section view, and a schematic end view, respectively, of a case of a gas turbine engine enclosing a chevron deployment mechanism, with chevrons stowed;

FIGS. 3A and 3B are a schematic enlarged section view, and a schematic end view, respectively, of the case of the gas turbine engine enclosing the chevron deployment mechanism of FIGS. 2A and 2B, with chevrons deployed;

FIG. 4 is a schematic rear view showing chevrons of the chevron deployment mechanism of FIG. 2A connected to reinforcement members of an end frame, in a stowed configuration and in a deployed configuration;

FIG. 5 is a schematic perspective view showing chevrons of the chevron deployment mechanism of FIG. 2A connected to an inner skin and an outer skin, in a stowed configuration and in a deployed configuration; and

FIG. 6 is a schematic enlarged section view of a case of a gas turbine engine enclosing a chevron deployment mechanism with a combination of rigid and flexible pressurizing lines.

### DETAILED DESCRIPTION OF THE PREFERRED EMBODIMENTS

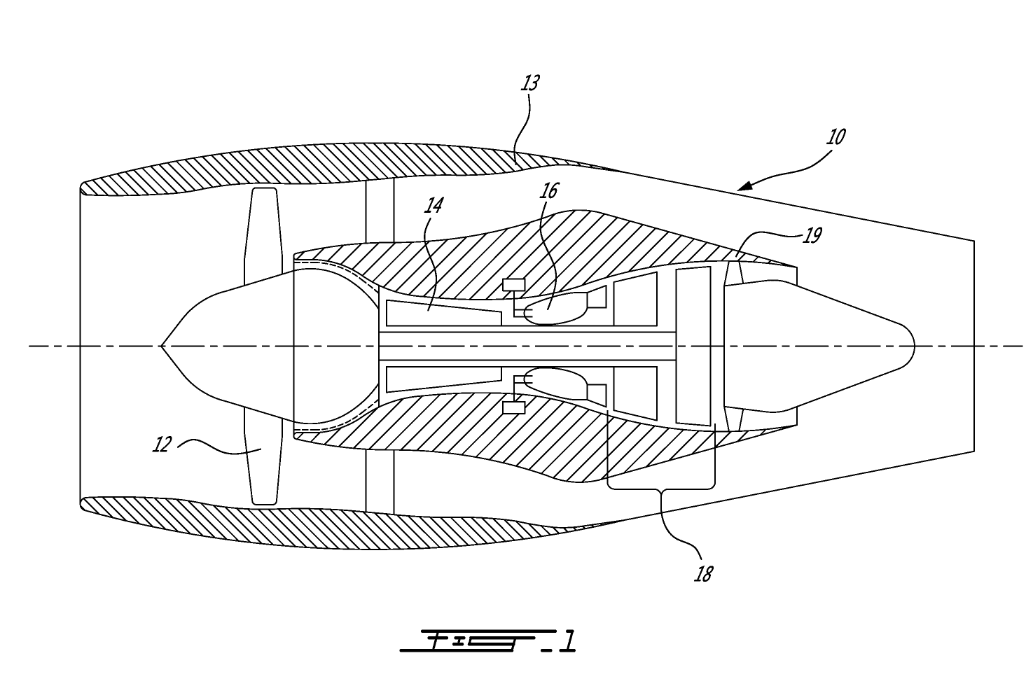

FIG. 1 illustrates a turbofan gas turbine engine 10 of a type preferably provided for use in subsonic flight, generally comprising in serial flow communication a fan 12 in an outer case 13 through which ambient air is propelled, a multistage compressor 14 for pressurizing the air, a combustor 16 in which the compressed air is mixed with fuel and ignited for generating an annular stream of hot combustion gases, and a turbine section 18 in a turbine case 19 for extracting energy from the combustion gases.

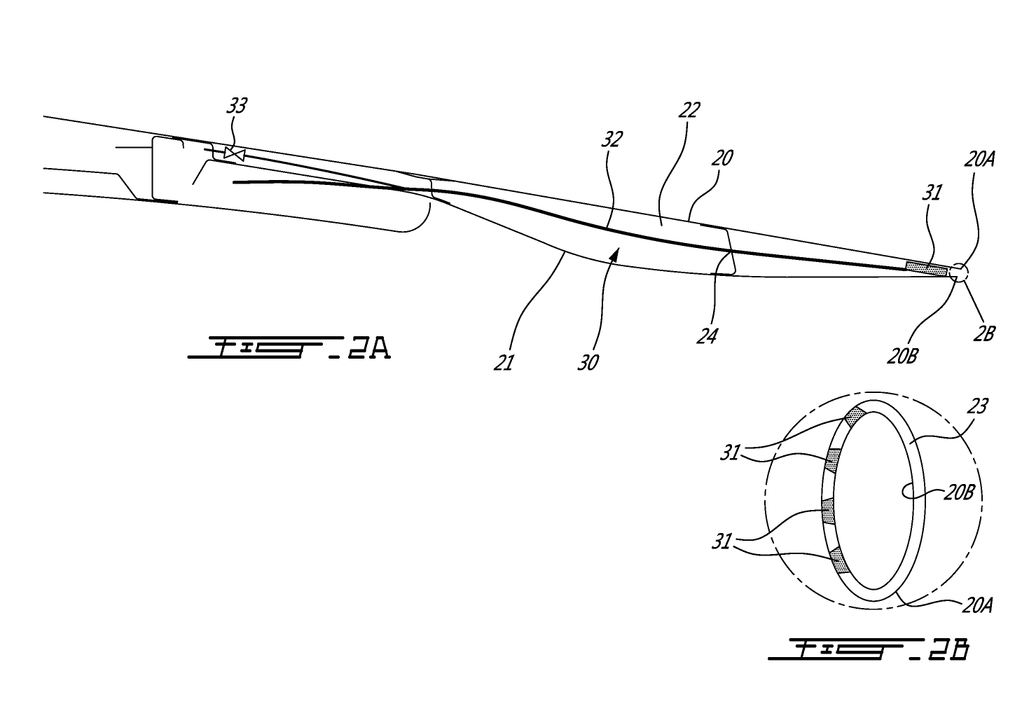

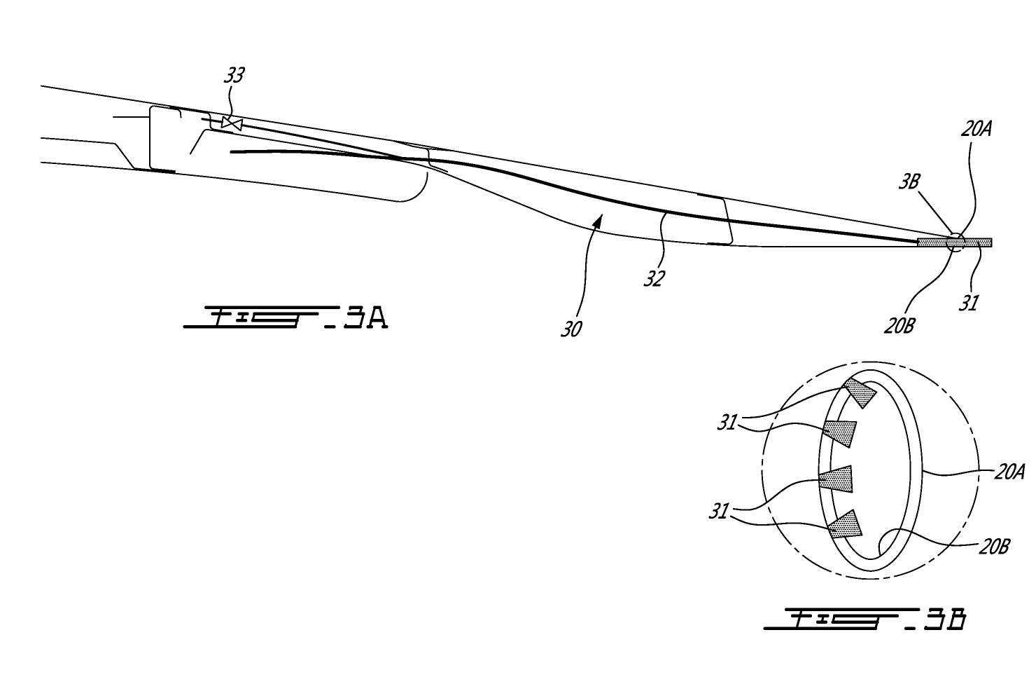

Referring to FIGS. 2A and 3A, a gas turbine engine case or nacelle that may or may not include a thrust reverser is shown as having an outer skin 20, an inner skin 21, so as to define an inner cavity 22 therebetween. The engine case is for instance the outer case 13, although it is contemplated to provide the chevron deployment mechanism described hereinafter in the turbine case 19 as well, as the chevrons may be useful in any of the exhaust cases of the gas turbine engine 10. For simplicity, the expression “case” will be used hereinafter. The gas turbine engine case is annular, whereby the inner cavity 22 is annular, as observed from FIGS. 2B and 3B. An annular opening 23 is circumscribed by trailing edges 20A and 21A of the outer skin 20 and of the inner skin 21. According to an embodiment, the outer skin 20 and the inner skin 21 are part of a thrust reverser, for instance forming an end frame pivotable at pivot frame 24, and separable from a remainder of the nacelle.

A chevron deployment mechanism is generally shown at 30, and is mostly concealed in the inner cavity 22. The mechanism 30 has chevrons 31 that may be inflated to a deployed configuration, as shown concurrently by FIGS. 3A and 3B, from a stowed configuration shown concurrently by FIGS. 2A and 2B. As observed in FIGS. 2B and 3B, the chevrons 31 are circumferentially distributed within the outer skin 20.

The chevrons 31 are inflatable members made using inflatable metals, such as inflatable steel, aluminum and/or copper based alloys that have the property of expanding (increasing in volume and showing an increased surface) when subjected to an inner pressure, and contract to an original shape upon pressure release, for instance by the presence of a plurality of folds enabling expansion and contraction. According to another embodiment non-metal chevrons 31 (e.g. rubber), provided such materials can sustain temperatures and pressures at tail ends of gas turbine engines. The expression “chevron” is used as inflatable members described below perform the same function as the sawtooth pattern chevrons integral with the outer skin of gas turbine engine cases. However, other expressions may be used to qualify such chevrons, such as silencers, flaps, tabs, sound-suppressing means, etc, all of which are encompassed by the present disclosure. The chevrons 31 may also include air-through chevrons, also known as hollow tabs. For simplicity, the expression chevron is used throughout the specification, but encompasses these other types of devices as well, and the expression “inflatable surface-increasing features” is used in the claims to cover the multiple possible embodiments described above.

The chevrons 31 may have any appropriate shape, although a trapezoidal or truncated triangular shape may be considered for noise reduction effectiveness such that the chevrons 31 flare beyond the trailing edge of the case to create increased singularities within the flow causing an enhancement of stream-wise vortices which may result in sharper plume decay and hence a noise reduction. The number of chevrons 31 may vary in number, in size and/or in disposition. Moreover, the chevrons need not all have the same shape and size.

The chevron deployment mechanism 30 also has pressurizing line or duct 32 that can convey a hydraulic fluid or pneumatic pressure, so as to fill up the inflatable chevrons 31 to transition from the stowed configuration of FIGS. 2A and 2B to the deployed configuration of FIGS. 3A and 3B. The pressurizing line 32 is part of a pressurizing system that inflates/deflates the chevrons 31. A single pressurizing line 32 is illustrated, but the chevron deployment mechanism 30 may have a network of ducts (i.e., pipe network, tubes, etc) so as to distribute pressurized fluid, for instance from a single or multiple sources, to the chevrons 31.

Hydraulic pressurization can be achieved through existing sources of hydraulic pressure on an engine, e.g. the actuation lines for the thrust-reversers can be modified appropriately for inflating the chevrons 31, with the pressurizing line 32 being pipe(s), conduit(s) to control the flow of fluid to the chevrons 31. Similarly, results can be achieved by using existing sources of hydraulic pressure on an aircraft, or using a separate stand-alone source (e.g., pump, reservoir, conduits, valves, etc). Similarly, pneumatic actuation can be achieved by using high pressure air available from the engine, for instance via a pressurizing duct feeding the pressurizing line 32, and/or a stand-alone source located on the engine or aircraft.

The chevron deployment mechanism 30 further comprises a depressurization portion controllable by valve 33 to release the pressure and thus cause a contraction of the chevrons 31 to the stowed configuration of FIGS. 2A and 2B. In the case of a hydraulic arrangement, the depressurization portion may be a pipe returning the hydraulic fluid into an appropriate reservoir. In the case of a pneumatic arrangement, the contraction of the chevrons 31 may be achieved through de-pressurization of the line 32, for example discharging air pressure to the surrounding environment. For example, if the deployment uses pneumatic pressure, the return line may not be required and the depressurizing may be achieved by discharging the pressure from the chevrons 31 directly into the thrust reverser.

The inflatable chevrons 31 lie between the outer skin 20 and inner skin 21. The chevrons 31 may be anchored to the surfaces of inner cavity 22, based on their contracted shape, to ensure that the chevrons 31 are concealed in the inner cavity 22 (i.e., they are substantially fore of the trailing edge 20A of the case) when contracted to the stowed configuration, so as not to hinder the flow around the outer and inner skins 20 and 21.

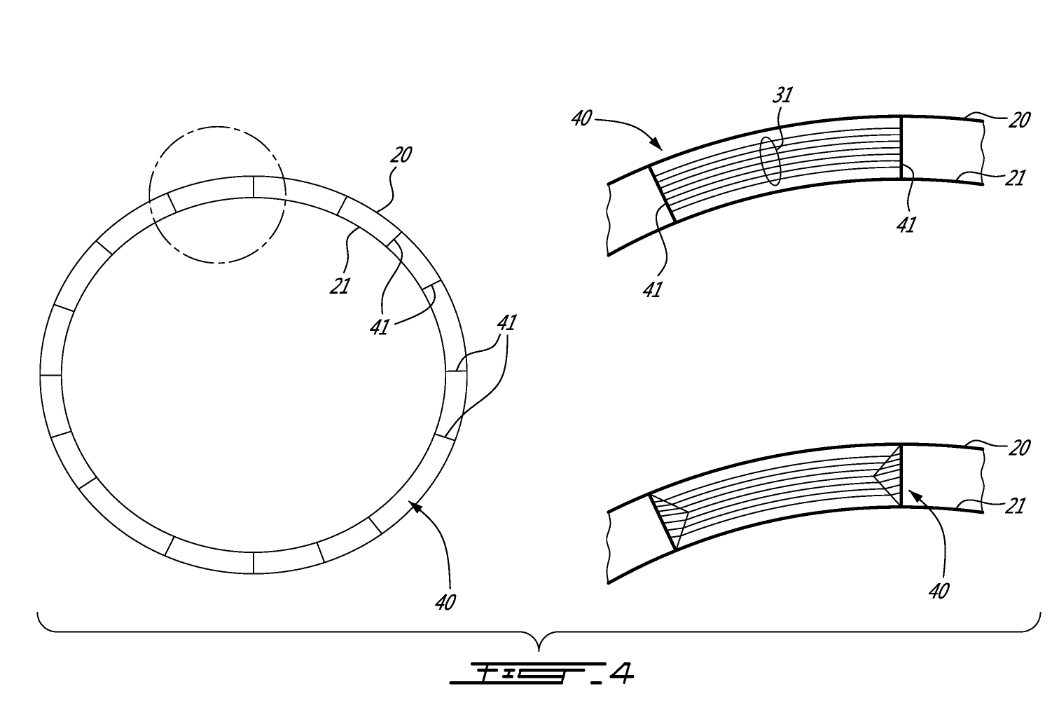

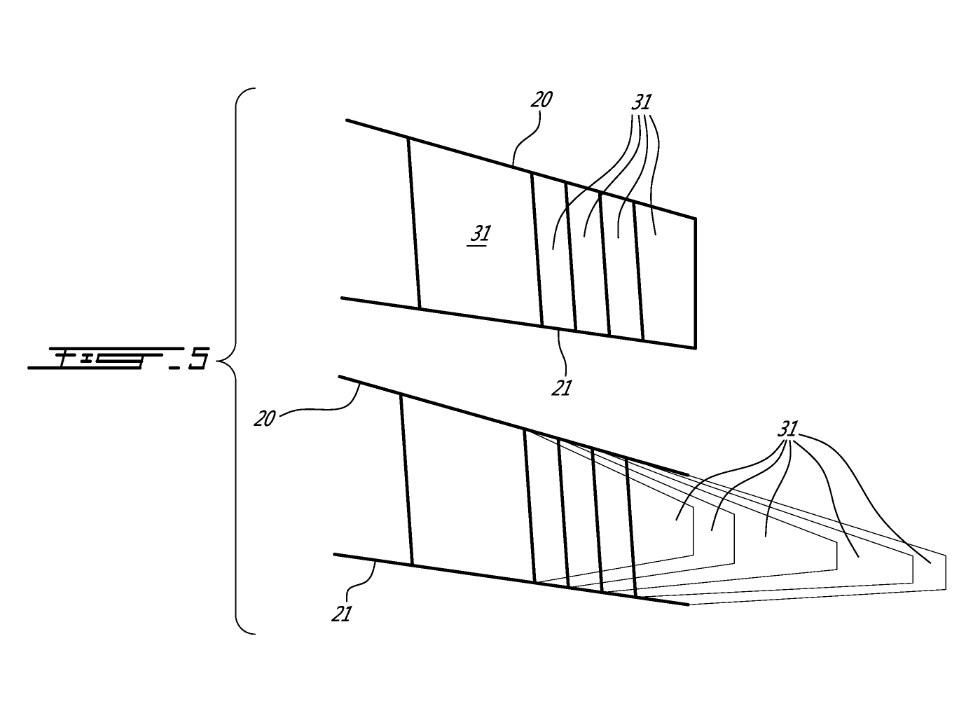

The inflatable chevrons 31 may be connected to an end frame 40 in different ways, which may include radially positioned in radial or axial directions or a combination thereof, as illustrated in FIGS. 4 and 5, respectively. For example, referring to FIG. 4, the end frame 40 is shown featuring the skins 20 and 21. Structural reinforcement members 41 may be transversely and radially disposed in the end frame 40 and extend between the skins 20 and 21, to reinforce the end frame 40. The inflatable chevrons 31 may be rigidly mounted to the reinforcement members 41 between the outer and inner skins 20 and 21, relieving the trailing edges of the end frame 40 of their structural functions of supporting the chevrons 31, and thus limiting the trailing edges of the end frame 40 to guiding the chevrons 31 into and out of their stowed and deployed configurations without having to directly support the chevrons 31. In this connection, the chevrons 31 may be connected by radially oriented joints to the reinforcement members 41, with mechanical fasteners, etc.

In another embodiment, shown in FIG. 5, the inflatable chevrons 31 may be rigidly mounted to the outer and inner skins 20 and 21. Joints connecting the chevrons 31 to the end frame 40 in this manner are axially oriented.

In another embodiment, the inflatable chevrons 31 may be rigidly mounted on slave sub-structures within the end frame 40 such that chevrons 31 undergo a translational movement to reach the trailing edge of the end frame 40 before being inflated to a deployed configuration.

In another embodiment, the end frame 40 may feature separate constructional details along different circumferential sectors, to allow for installation of the inflatable chevrons only along a specific sector of the end frame 40.

When the skins 20 and 21 are part of a thrust reverser, the pressurizing line 32 may have flexible portions at a pivoting location of the thrust reverser, so as not to hamper the pivoting movement, yet remain connected to a pressure source upstream of the thrust reverser. The line 32 used for conveying the fluid for pressurizing and depressurizing the inflatable chevrons 31 may be constituted of completely flexible lines or a combination of rigid and flexible pipelines packaged between the outer skin 20 and the inner skin 21 of the thrust reverser.

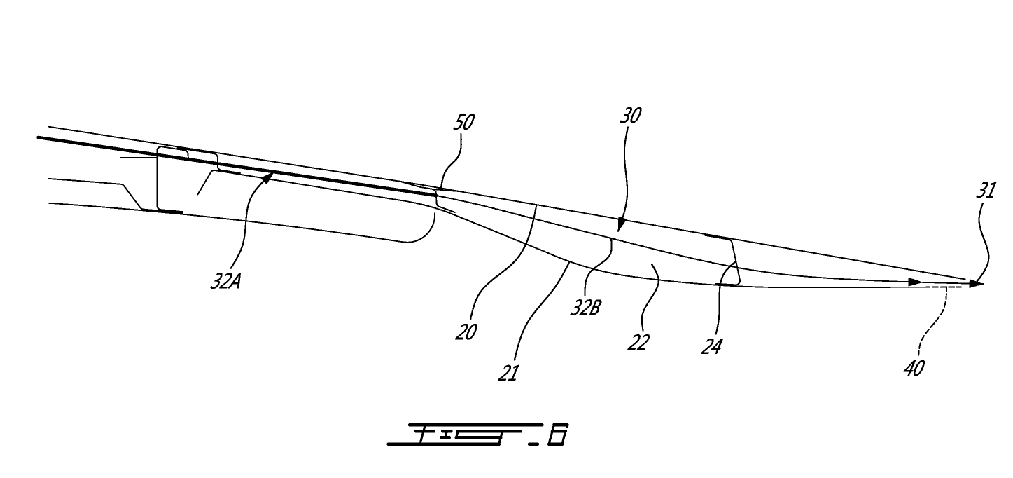

Referring to FIG. 6, the transition of the rigid line 32A to the flexible line 32B may occur at the junction 50 of the thrust reverser pivot door or pivot frame with a remainder of the engine nacelle, although other transitions may be used. Another embodiment may feature a single line from the pressurizing source diverging in multiple lines at a splitter to the multiple chevrons 31. Similarly, another embodiment may feature multiple pressurizing sources that may activate single or multiple ones of the chevrons 31.

In the deployed configuration, the pressurizing line 32 conveys the hydraulic/pneumatic pressure to the chevrons 31, inflating them past the trailing edges of skins 20 and 21. As observed from FIG. 3B, the inflated shape extends beyond the trailing edges of the skins 20 and 21, whereby the chevrons 31 interact with the flow streams around the skins 20 and 21, thus creating a vortical flow structure that contributes to jet noise reduction. The deployed configuration may be used at a typical take-off and/or landing maneuver, such that the inverted chevrons 31 expose the active surfaces, thereby initiating a stronger vortical flow, resulting in a reduction in the jet noise.

The chevron deployment mechanism 30 may be designed to operate in a ‘FAIL-CLOSE’ mode wherein the inflatable chevrons 31 continuously stay in the stowed configuration, so as to minimize the hydraulic/pneumatic load under the failure condition.

Therefore, a method for deploying the chevrons 31 at a trailing edge 20A of the case comprises directing pressurized fluid to the plurality of chevrons 31 at the of the case, and inflating the plurality of chevrons 31 to a deployed configuration in which the chevrons 31 extend beyond the trailing edge 20A of the gas turbine engine. The chevrons 31 are then deflated to a stowed configuration in which the chevrons 31 are substantially fore of the trailing edge 20A of the case. The inflating of the chevrons 31 may occur when the aircraft is in at least one of a take-off and landing maneuver, and may comprise inflating the chevrons to flare away from the trailing edge. Fluid may be directed from a hydraulic source of the aircraft to the chevrons, or may be directed in a duct 32 formed between the inner skin 21 and the outer skin 20 of the aircraft to the chevrons 31. The portion of the case enclosing the chevrons 31 may be deployed in a thrust reverser configuration when the chevrons 31 are in their stowed configuration.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

What is claimed is:

1. A deployment mechanism for inflatable surface-increasing features a gas turbine exhaust case comprising:
a plurality of inflatable surface-increasing features adapted to be circumferentially distributed within the gas turbine exhaust case at a trailing edge thereof, the inflatable surface-increasing features being inflatable from a stowed configuration in which the inflatable surface-increasing features are substantially concealed fore of the trailing edge, to a deployed configuration in which the inflatable surface-increasing features extend beyond the trailing edge; and
a pressurizing system in fluid communication with the plurality of chevrons to inflate and deflate the inflatable surface-increasing features.

2. The chevron deployment mechanism according to claim 1, wherein each said inflatable surface-increasing features is made of an inflatable metal.

3. The chevron deployment mechanism according to claim 1, wherein each said inflatable surface-increasing features is made of an inflatable rubber.

4. The chevron deployment mechanism according to claim 1, wherein each said inflatable surface-increasing features has a truncated triangular shape.

5. The chevron deployment mechanism according to claim 1, wherein at least one of said inflatable surface-increasing features is oriented to flare beyond the trailing edge.

6. A gas turbine engine comprising:
a turbine case defining an annular cavity;
a plurality of inflatable surface-increasing features circumferentially distributed within the annular cavity at a trailing edge thereof, the inflatable surface-increasing features being inflatable from a stowed configuration in which the inflatable surface-increasing features are substantially concealed within the turbine case, to a deployed configuration in which the inflatable surface-increasing features extend outside the turbine case at the trailing edge, and
a pressurizing system in fluid communication with the plurality of inflatable surface-increasing features to inflate and deflate the inflatable surface-increasing features between the stowed configuration and the deployed configuration.

7. The gas turbine engine according to claim 6, wherein the case has an inner skin, with an annular cavity formed between the inner skin and the outer skin, the inflatable surface-increasing features being at least partially located in the annular cavity

8. The gas turbine engine according to claim 6, wherein the pressurizing system is connected to a pneumatic system or an hydraulic system of the gas turbine engine.

9. The gas turbine engine according to claim 6, further a portion of the outer skin supporting the plurality of inflatable surface-increasing features is deployable to thrust reverser configuration.

10. The gas turbine engine according to claim 9, wherein the pressurizing system comprises flexible lines on a thrust reverser portion of the case, and rigid lines secured to a remainder of the case.

11. The gas turbine engine according to claim 7, wherein the inflatable surface-increasing features is connected to the inner skin and to the outer skin by axially oriented joints.

12. The gas turbine engine according to claim 7, further comprising reinforcement members extending radially between the inner skin and the outer skin, the chevrons being connected to the reinforcement members by radially oriented joints.

13. A method for deploying chevrons at a trailing edge of a gas turbine exhaust case of an aircraft, comprising:
directing pressurized fluid to a plurality of inflatable surface-increasing features at the trailing edge of the exhaust case; and
inflating the plurality of inflatable surface-increasing features to a deployed configuration in which the inflatable surface-increasing features are inflated to extend beyond the trailing edge of the exhaust case.

14. The method according to claim 13, further comprising deflating the inflatable surface-increasing features to a stowed configuration in which the inflatable surface-increasing features are substantially fore of the trailing edge of the exhaust case.

15. The method according to claim 13, wherein inflating comprises inflating the inflatable surface-increasing features when the aircraft is in at least one of a take-off and landing maneuver.

16. The method according to claim 13, inflating comprises inflating the inflatable surface-increasing features to flare away from the trailing edge.

17. The method according to claim 13, wherein directing pressurized fluid comprises directing fluid from a hydraulic source of the aircraft to the inflatable surface-increasing features.

18. The method according to claim 13, wherein directing pressurized fluid comprises directing fluid in a duct formed between an inner skin and an outer skin of the aircraft to the inflatable surface-increasing features.

19. The method according to claim 13, further comprising deploying a portion of the exhaust case enclosing the inflatable surface-increasing features in a thrust reverser configuration.
